(19) United States
(12) Patent Application Publication
(10) Pub. No.: US 2023/0391562 A1
(43) Pub. Date: Dec. 7, 2023

(54) DEVICE FOR HANDLING CONTAINERS INSIDE A CLEAN ROOM, A SYSTEM AND A CLEAN ROOM COMPRISING A CORRESPONDING DEVICE, AND A METHOD FOR HANDLING CONTAINERS INSIDE A CLEAN ROOM

(71) Applicant: Syntegon Technology GmbH, Waiblingen (DE)

(72) Inventors: Markus Ilgenfritz, Feuchtwangen (DE); Ulrich Krauss, Ilshofen (DE); Stefan Nagler, Unterschneidheim (DE); Albrecht Kühnle, Crailsheim (DE); Patrick Holl, Crailsheim (DE)

(21) Appl. No.: 18/249,432

(22) PCT Filed: Sep. 17, 2021
(86) PCT No.: PCT/EP2021/075692

§ 371 Date: Apr. 18, 2023

(30) Foreign Application Priority Data
Oct. 29, 2020 (DE) 10 2020 128 519.1

(51) Int. Cl. B65G 47/90

(52) U.S. Cl. CPC B65G 47/90; B65G 2201/0235

(57) ABSTRACT

The invention relates to a device (10) for handling containers (12) inside a clean room, to a system comprising a corresponding device (10), at least one container (12) and/or one nest (30), to a clean room having a corresponding device (10) and to a method for handling containers (12) inside a clean room.

### BACKGROUND

The invention relates to a device for handling containers inside a clean room, to a system comprising a corresponding device, to a clean room with a corresponding device and to a method for handling containers inside a clean room.

In the prior art, the handling and fixing of pharmaceutical containers (e.g., vials, syringes, carpules) or packaging material (e.g., tubs, trays, nests, Tyvek films) in a sterile environment is based on the production of a holding force by vacuum or by mechanical gripping with positive and non-positive connection (pneumatic or electrical grippers).

The previously known and available solutions for handling or fixing pharmaceutical objects or packaging materials have various disadvantages, which are of particular relevance when they are used in a sterile environment (such as an isolator of a pharmaceutical dosing system).

Handling or fixing with vacuum has several disadvantages, in particular when processing toxic/highly potent active substances and when used on a robot/handling device.

After the machine has been set up, it must be ensured for a decontamination cycle with H2O2 (hydrogen peroxide) that H2O2 also flows through the vacuum channels and the vacuum channels are thus decontaminated. Since sometimes a plurality of suction cups are present on an assembly (e.g., grippers for a plurality of vials), it is difficult to ensure that a sufficient amount of H2O2 passes through all suction cups. In the case of toxic and highly potent active substances, a filter must additionally be provided which prevents, for example, aerosols of the active substance from passing from the interior of the isolator to the exterior as a result of the vacuum.

In the case of toxic and highly potent active substances, dismantling the machine also poses a challenge, since the vacuum lines of the respective component/assembly are potentially contaminated with the active substance up to the filter, and these cannot be reached when washing down with water.

Thus, the entire component/assembly must either be packed manually into a sealed bag by the operator using glove ports and later cleaned separately, or be automatically unloaded, for example, by a robot via a port or lock system. When using a classic vacuum gripper with suction cups on, for example, a robot or a handling device (e.g., for handling pharmaceutical containers), the vacuum also has the significant disadvantage that the freedom of movement of the robot/handling device is significantly restricted by the vacuum line. On the one hand, the vacuum lines must be prevented from rubbing against the robot/handling device and generating particles and, on the other hand, it must be prevented that the vacuum lines protrude too far from the robot/handling device and the robot collides with other stations in the system or becomes caught thereon. This disadvantage also exists with pneumatically or electrically driven grippers.

The previous solution, which is based on mechanical gripping/fixing, has the disadvantage, for example, that it is difficult to remove upside-down vials from a tray with a mechanical gripper, since the vials stand close together in the tray. In this case, a mechanical gripper must additionally be adapted to the object to be gripped (e.g., vial with a specific diameter).

Furthermore, mechanical gripping has the disadvantage that auxiliary energy (e.g., electrical energy or compressed air) is required for the gripping movement (e.g., gripper stroke), which in turn requires a line on the robot/handling device.

### SUMMARY

The object of the present invention is to provide a device for handling containers and/or packaging material inside a clean room, a system comprising a corresponding device, a clean room with a corresponding device and a method for handling containers and/or packaging material inside a clean room, which overcome the above disadvantages.

The invention allows pharmaceutical containers (e.g., vials, syringes, carpules) or packaging material (e.g., tubs, trays, nests, Tyvek films) to be handled and fixed in a simple and secure manner in a sterile environment.

Containers are predominantly referred to below, but these embodiments also apply to the fixing and/or handling of packaging material.

The above-mentioned object is achieved by a device for handling containers inside a clean room (e.g., an isolator of a pharmaceutical machine), in particular in a sterile environment, wherein the device comprises:

a gripper having at least one tool. The gripper can be designed as a robot arm and can, for example, be pneumatically, electrically, or hydraulically movable.

The tool has at least one contact surface. This is designed to contact at least one container and/or packaging material in a planar region.

The containers are in particular pharmaceutical containers such as vials, syringes, or carpules.

An adhesive-structured polymer film is arranged at least partially on the contact surface. Alternatively, the contact surface can have an adhesive-structured polymer surface, in particular a polymer coating. In particular, the adhesive-structured polymer film or the adhesive-structured polymer surface, in particular the polymer coating, can cover the entire contact surface.

The adhesive-structured polymer film or the adhesive-structured polymer surface, in particular the polymer coating, is designed such that the contacted container adheres to the adhesive-structured polymer film or to the adhesive-structured polymer surface, in particular the polymer coating, as a result of intermolecular forces, in particular van der Waals interactions. In other words, the container is held by intermolecular forces, in particular van der Waals interactions, between the container and the adhesive-structured polymer film or the adhesive-structured polymer surface, in particular the polymer coating.

The adhesive-structured polymer film or the adhesive-structured polymer surface can have, for example, a microstructure and/or a mesostructure. It is also conceivable for a macrostructure to be provided which causes adhesion as a result of intermolecular forces, in particular van der Waals interactions. The corresponding structuring of the surface, in particular the microstructure and/or mesostructure, causes increased intermolecular forces, in particular van der Waals interactions, between the structure or film or surface and the object to be held.

As a result, containers can be handled (e.g., fixed, transported) without the need for auxiliary energy in the form of, for example, vacuum, compressed air or electrical energy. Additional lines (supply lines) for electrical current or compressed air are superfluous. This simplifies the use of the device inside a clean room and in particular in a sterile environment. Additional lines represent an interface between the clean room (or isolator) and the environment and thus potential weak points, which must be isolated/controlled with additional (structural) modifications.

For example, the device can be used to remove upside-down containers, such as vials, from a tray. For this purpose, the adhesive-structured polymer film or the adhesive-structured polymer surface, in particular the polymer coating, which is attached, for example, to a robot tool or a moving machine part, can be pressed onto the base of the vial with a certain pressure for a certain amount of time.

The adhesive-structured polymer film or the adhesive-structured polymer surface, in particular the polymer coating, adheres to the glass as a result of van der Waals forces and the upside-down vials can be lifted out of the tray and transported further, turned and/or sorted into another nest.

In order to detach the container adhering to the adhesive-structured polymer film or the adhesive-structured polymer surface, in particular the polymer coating, the tool or the contact surface can be angled. This changes the angle between the microstructure of the polymer film or the polymer surface, in particular the polymer coating, and the contacted container surface, so that the van der Waals bond is broken (cf. gecko effect).

The device can be used for transporting pharmaceutical containers (e.g., vials, syringes or carpules). In this case, the adhesive-structured polymer film or the adhesive-structured polymer surface, in particular the polymer coating, can produce the holding force, which was previously produced by vacuum or mechanical gripping.

The device can also be used for stabilizing/fixing vials when lifting them out of a nest (for example for denesting, rejects or sampling). This can be particularly important for tall, slim vials (e.g., 4R format).

According to a development, the adhesive-structured polymer film or the adhesive-structured polymer surface, in particular the polymer coating, can be made of silicone. As a result, simple production, for example by injection molding, is possible. In addition, silicone can be easily cleaned and disinfected. Furthermore, silicone is elastic, so that contacting of the container can be implemented as gently as possible. Damage to the containers to be handled (e.g., scratches or glass breakage) can thus be avoided.

According to a development, the tool and/or the adhesive-structured polymer film can be designed as a replaceable part or as a disposable part. This allows easy replacement in the event of contamination, damage and/or wear. This makes it easier to continue meeting the high demands placed on a sterile environment when handling pharmaceutical containers.

According to a development, the adhesive-structured polymer film or the adhesive-structured polymer surface, in particular the polymer coating, can be designed to be H2O2-resistant (hydrogen peroxide-resistant) and/or autoclavable. As a result, decontamination by means of H2O2 or an autoclave can be realized. Thus, the adhesive-structured polymer film or the adhesive-structured polymer surface, in particular the polymer coating, can be decontaminated or disinfected in a simple and safe manner, which optimizes the use of the device in a sterile environment.

According to a development, the tool can have at least one resilient element. This can be designed in the form of a spring, for example a spiral spring or a helical spring. In this case, the contact surface can be pretensioned by means of the resilient element, so that a force exerted on the contact surface acts against a restoring force of the resilient element. In other words, the contact surface can be designed to be resilient relative to the tool. As a result, length tolerances (e.g., in the case of glass vials) and positioning inaccuracies of the device can be compensated for.

According to a development, the tool can be pin-like. The contact surface can be arranged at one end of the pin-like tool. This allows the handling of very thin containers packed tightly within a nest or tray. Preferably, the thickness (or diameter) of the pin-like tool is smaller than the thickness (or diameter) of the container to be handled. It can thus be ensured that the containers adjacent to the container to be handled are not damaged by the handling.

According to a development, the contact surface can be designed to be planar, in particular circular. This facilitates the contacting of containers on their base, which is mostly planar and, in particular, circular. Thus, the entire base or at least a large part of the base surface can be contacted with the adhesive-structured polymer film or the adhesive-structured polymer surface, in particular the polymer coating. As a result of the larger contact surface on the container, stronger van der Waals forces can act, so that secure handling can be ensured. It is also conceivable for a plurality of containers to be contacted simultaneously on their bases by means of an adhesive-structured polymer film or adhesive-structured polymer surface, in particular a polymer coating.

According to a development, the contact surface can be designed to be partially cylindrical, semi-cylindrical, in particular semi-circular cylindrical (the contact surface corresponds to a part of a lateral surface of a cylinder, a semi-cylinder, in particular a semi-circular cylinder). This facilitates the contacting of containers on their mostly cylindrical and in particular circular cylindrical body. Preferably, the curvature of the contact surface corresponds to the curvature of the container to be contacted. In particular, the extension of the curvature of the contact surface corresponds to half the circumference of the container in the region on which the container is to be contacted. Thus, a large region of the container can be contacted with the adhesive-structured polymer film or the adhesive-structured polymer surface, in particular the polymer coating. As a result of the larger contact surface on the container, stronger van der Waals forces can act, so that more secure handling can be ensured.

According to a development, the tool can be designed to simultaneously contact a plurality of containers, in particular arranged in a nest or tray. Each contacted container can be contacted with a contact surface of the tool. Thus, a plurality of, in particular all, containers of a nest or tray can be removed, handled and/or placed in a nest or tray in a particularly quick and simple manner.

According to a development, the contact surface can be arranged on a flexible and/or deformable portion of the tool. The contact surface can thus adapt to a contour of the container by pressing. Thus, differently shaped containers can be handled with the same tool and the device can be used more flexibly. Unevenness of the surface to be contacted on the container (e.g., dents, bulges on the base of the container) can thus be compensated for.

The object to be achieved is further achieved by a system according to the disclosure. The system comprises a device having the features described above. The system can further comprise a container, in particular a pharmaceutical container, such as a vial, a syringe or a carpule. In addition, the system can comprise a nest, tray or tub. The nest, tray or tub can be designed to accommodate a plurality of containers. These can be arranged upright and/or upside down in the nest, tray or tub. In this case, the contact surface is designed to be complementary to a container, so that the contact surface can lie flat against the container. In particular, the contact surface is designed to be complementary to a planar region of the container, e.g., the base or body of the container.

With regard to the advantages that can be achieved with the system, reference is made to the statements relating to the device in this respect. The measures described in connection with the device can serve for developing the system.

The object to be achieved is further achieved by a clean room according to the disclosure. The clean room comprises a device having the features described above or a system having the features described above.

With regard to the advantages that can be achieved with the clean room, reference is made to the statements relating to the device or the system in this respect. The measures described in connection with the device or the system can serve for developing the clean room.

The object to be achieved is further achieved by a method for handling containers, in particular pharmaceutical containers such as vials, syringes, or carpules, inside a clean room (e.g., an isolator of a pharmaceutical machine), in particular in a sterile environment, wherein the method comprises the steps of:

providing a contact surface for contacting a container. In this case, an adhesive-structured polymer film is arranged at least partially on the contact surface. Alternatively, the contact surface can have an adhesive-structured polymer surface, in particular a polymer coating. The adhesive-structured polymer film or the adhesive-structured polymer surface, in particular the polymer coating, is designed such that the contacted container adheres to the adhesive-structured polymer film or to the adhesive-structured polymer surface, in particular the polymer coating, as a result of a van der Waals interaction.

pressing the contact surface with the adhesive-structured polymer film or the adhesive-structured polymer surface, in particular the polymer coating, onto the container. The pressing is carried out with a predetermined pressure and for a predetermined time period. This ensures that the microstructure of the polymer film or the polymer surface, in particular the polymer coating, can adapt sufficiently well to the container or its surface.

handling the container adhering to the adhesive-structured polymer film or the adhesive-structured polymer surface, in particular the polymer coating, as a result of van der Waals forces.

In order to detach the container adhering to the adhesively structured polymer film or the adhesively structured polymer surface, in particular the polymer coating, the contact surface can be angled. This changes the angle between the microstructure of the polymer film or the polymer surface, in particular the polymer coating, and the contacted container surface, so that the van der Waals bond is broken (cf. gecko effect). A detachment of adhered containers is also achieved by “overpressing” (overpressing: the individual polymer hairs are designed such that they buckle and detachment occurs as a result) or by pulling off, twisting off or shearing off.

According to a further development, the method can further comprise the step of:

positioning the container in a nest or tray and/or removing the container from a nest or tray. Thus, batches of containers that are transported in a nest or tray can be handled. Handling or transporting containers between two nests or trays is also conceivable.

According to a development, a device having the features described above or a system having the features described above can be used to carry out the method. Alternatively, the method can be carried out in a clean room according to the disclosure.

### BRIEF DESCRIPTION OF THE DRAWINGS

Further features, details and advantages of the invention emerge from the wording of the claims and from the following description of exemplary embodiments with reference to the drawings in which:

FIG. 1 is a perspective view of a device;

FIG. 2 is a perspective view of a tool of the device according to FIG. 1;

FIG. 3 is a perspective view of a further exemplary embodiment of the device;

FIG. 4 is a perspective view of a tool of the device according to FIG. 3;

FIG. 5 is a perspective view of a further exemplary embodiment of the device; and

FIG. 6 is a sectional view of a tool of the device according to FIG. 5.

### DETAILED DESCRIPTION

In the following description and in the figures, corresponding components and elements bear the same reference signs. For improved clarity, not all reference signs are reproduced in all figures.

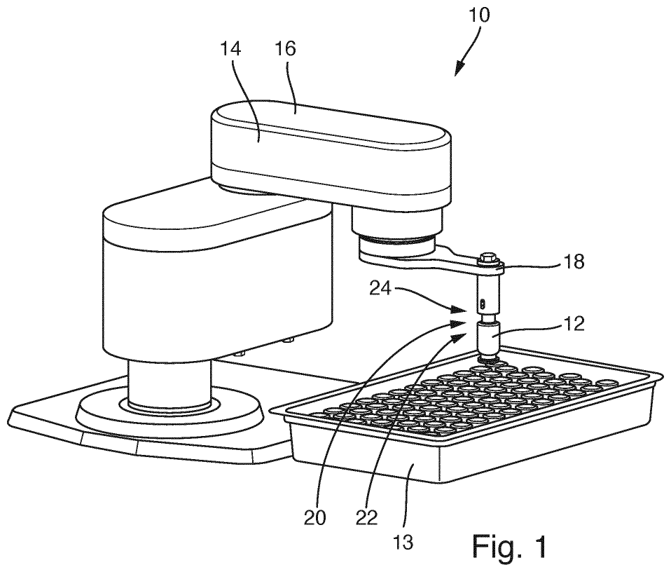

FIG. 1 is a perspective view of a device 10 for handling containers 12 inside a clean room. The device 10 has a gripper 14. In the present case, this is designed as a robot arm 16. The gripper 14 or the robot arm 16 has a tool 18 which is arranged as an end effector on the gripper 14 or the robot arm 16.

In the present case, a container 12, here a glass vial, can be handled with the tool 18. In the present case, the glass vials are arranged upside down in a tray, a trough-shaped receptacle 13 from which a single glass vial can be removed and handled by means of the tool 18.

In the present case, a plurality of containers 12 are arranged close together in the receptacle 13 (the receptacle is in the present case designed as a tray). Handling with a gripping tool, which handles a container 12 by gripping, would be a hindrance here.

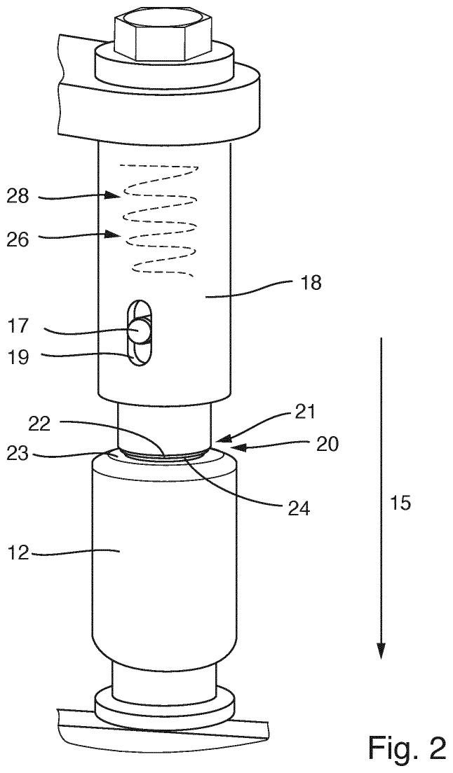

FIG. 2 is a perspective view of a tool 18 of the device 10 according to FIG. 1. The tool 18 has a contact surface 20. In the present case, this is designed to be planar and circular. In the present case, an adhesive-structured polymer film 22 is arranged on the contact surface 20. Instead of the polymer film 22, the contact surface 20 can have an adhesive-structured polymer coating 24.

The polymer film 22 or the polymer coating 24 is also designed to be planar and circular, so that almost the entire contact surface 20 is covered by the polymer film 22 or the polymer coating 24.

The container 12 shown has a planar, circular base 23 on which the polymer film 22 or the polymer coating 24 contacts the container 12. An adhesive effect occurs between the polymer film 22 or the polymer coating 24 and the contacted surface (base 23 of the container 12) as a result of a van der Waals interaction. For this purpose, the contact surface 20 with the polymer film 22 or the polymer coating 24 is pressed onto the base 23 of the container 12 with a certain pressure and for a certain amount of time. The microstructure of the polymer film 22 or the polymer coating 24 adapts to the base 23 of the container 12, so that the van der Waals forces between the microstructure and the base 23 of the container 12 can set in or act.

To detach the container 12 from the polymer film 22 or the polymer coating 24, the contact surface 20 is angled in relation to the container 12 or to the surface contacted on the container 12 (in the example shown, the base 23 of the container 12), so that the van der Waals forces can be released again (cf. gecko effect). A detachment of adhered containers is also achieved by “overpressing” (overpressing: the individual polymer hairs are designed such that they buckle and detachment occurs as a result) or by pulling off, twisting off or shearing off.

Since the holding force is realized by van der Waals forces, no additional connections/lines are required for the supply of compressed air or electrical current, for example, to the tool 18 for gripping/handling the container 12. The device 10 is therefore particularly suitable for use in an isolator and in particular in a sterile environment. Here, additional lines would represent an additional interface between the sterile atmosphere of the isolator and the environment.

In the present case, the tool 18 has at least one resilient element 26. This is designed in the form of a spring 28, which is merely indicated in FIG. 2 by a dashed line. The spring 28 pretensions the contact surface 20. If the contact surface 20 is placed on a container 12, the contact surface 20 springs back accordingly.

In the present case, the tool 18 has an extension 17 and a groove 19, wherein the extension 17 projects into the groove 19. The extension 17 and the groove 19 serve as a stop for the spring 28 and limit the movement of the contact surface 20 along a longitudinal direction 15 of the tool 18.

The pressure that is exerted on the container 12 during contact can be influenced by the above-described cushioning of the contact surface 20. In addition, for example, different heights of the containers 12 can be compensated for by the cushioning.

The contact surface 20 can be arranged on a flexible and/or deformable portion 21 of the tool 18. The contact surface 20 can thus adapt to a contour of the container 12 by pressing. For example, unevenness within a certain tolerance range of the contacted region of the container 12 can be compensated for.

In the present case, the tool 18 is pin-like. In other words, the tool 18 has an elongated shape and extends along its longitudinal axis 15. As a result, containers 12 which are arranged close together, for example in a receptacle 13 or a nest 30, can also be handled.

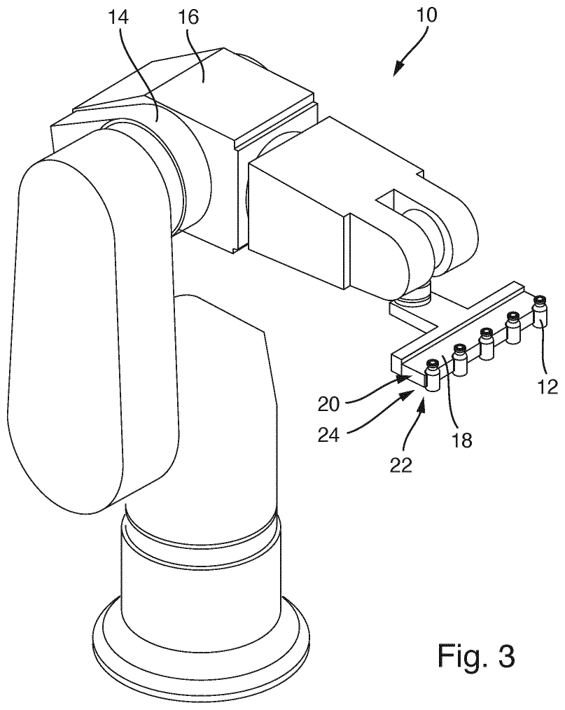

FIG. 3 is a perspective view of a further exemplary embodiment of the device 10. In this embodiment too, the gripper 14 is designed in the form of a robot arm 16. In the present case, the tool 18 is designed for simultaneous handling of five containers 12. For this purpose, the tool 18 has five contact surfaces 20, which have an adhesive-structured polymer film 22, or are coated with an adhesive-structured polymer coating 24. In the present case, all five contact surfaces 20 are identical. It is, of course, also conceivable for the contact surfaces 20 to be designed differently, for example to handle different containers 12 or containers 12 of different shapes and/or formats.

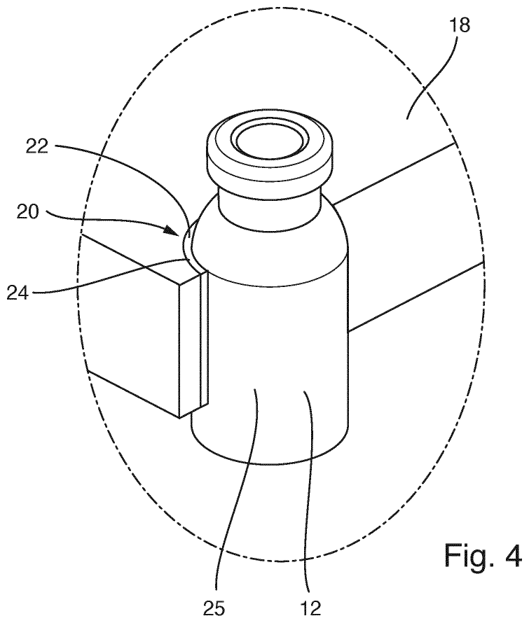

FIG. 4 is a perspective view of a tool 18 of the device 10 according to FIG. 3. One of the five identical contact surfaces 20 is shown. The contact surface 20 has the shape of a semi-circular cylinder. The container 12 has a body 25 which likewise has the shape of a semi-circular cylinder. Thus, the contact surface 20 can adapt optimally to the semi-circular cylindrical shape of the body 25 of the container 12.

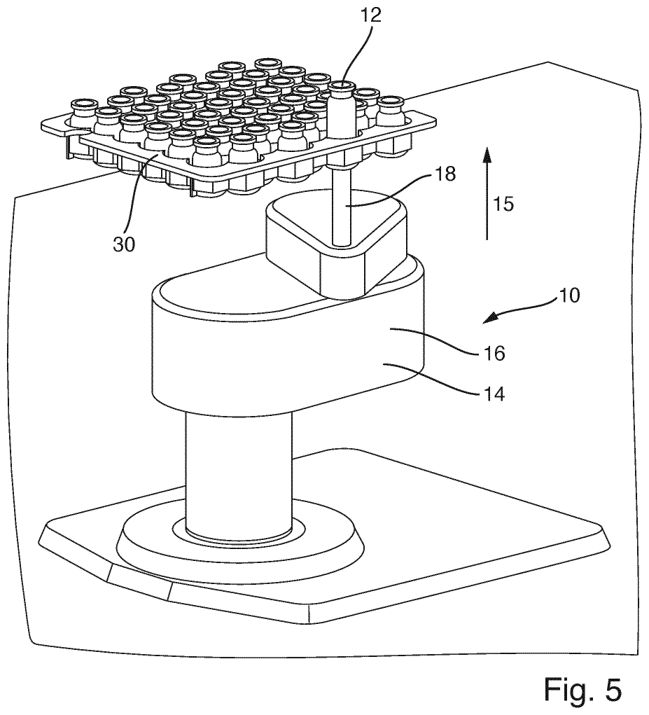

FIG. 5 is a perspective view of a further exemplary embodiment of the device 10. In this embodiment too, analogously to the two above, the gripper 14 is designed in the form of a robot arm 16.

In the present case, the containers 12 are arranged upright in the nest 30. The tool 18 is pin-like and extends longitudinally along the longitudinal axis 15. The tool 18 is designed to contact the containers 12 on the substantially planar base 23. The contact surface 20 is correspondingly designed as a planar surface.

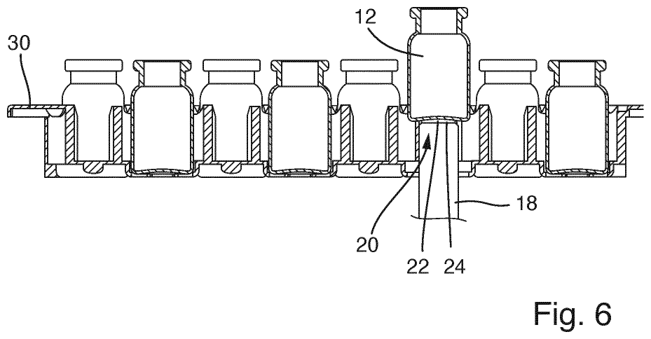

FIG. 6 is a sectional view of a tool 18 of the device 10 according to FIG. 5. In the sectional view, the nest 30 and further containers 12 arranged upright in the nest 30 are also shown.

The containers 12 can be lifted out of the nest 30 from below by means of the pin-like tool 18. In this case, the container 12 to be handled or lifted is fixed to the tool 18 by means of the adhesive-structured polymer film 22 or the adhesive-structured polymer coating 24.

As a result of the pin-like shape of the tool 18, a container 12 can be lifted out from between the adjacent containers 12 without the adjacent containers 12 representing an obstacle for the handling/lifting of the container 12.

In the illustrated embodiment, only a single pin-like tool 18 is shown for handling a container 12. Of course, it is conceivable that a plurality of pin-like tools 18 are provided in order to handle a plurality of containers 12 simultaneously. The same applies to the exemplary embodiment shown in FIGS. 1 and 2.

1. A device (10) for handling containers (12) and/or packaging material inside a clean room, comprising:
a gripper (14) having at least one tool (18),
wherein the tool (18) has a contact surface (20) configured to contact at least one container (12) and/or packaging material in a planar region,
wherein,
an adhesive-structured polymer film (22) is arranged at least partially on the contact surface (20), or the contact surface (20) has an adhesive-structured polymer surface, wherein the polymer film (22) or the polymer surface is designed such that the contacted container (12) and/or packaging material adheres to the polymer film (22) or to the polymer surface, as a result of a van der Waals interaction, wherein the polymer film (22) or the polymer surface is configured to be H2O2-resistant and/or autoclavable.

2. The device (10) according to claim 1, wherein the polymer film (22) or the polymer surface is made of silicone.

3. The device (10) according to claim 1, wherein the tool (18) and/or the polymer film (22) is configured as a replaceable part or as a disposable part.

4. (canceled)

5. The device (10) according to claim 1, wherein the tool (18) has at least one resilient element (26), wherein the contact surface (20) is pretensioned by the resilient element (26), so that a force exerted on the contact surface (20) acts against a restoring force of the resilient element (26).

6. The device (10) according to claim 1, wherein the tool (18) is pin-like, wherein the contact surface (20) is arranged at one end of the pin-like tool (18).

7. The device (10) according to claim 1, wherein the contact surface (20) is planar.

8. The device (10) according to claim 1, wherein the contact surface (20) is semi-cylindrical.

9. The device (10) according to claim 1, wherein the tool (18) is configured to simultaneously contact a plurality of containers (12) and/or packaging materials, wherein each contacted container (12) and/or packaging material is contacted with the contact surface (20) of the tool (18).

10. The device (10) according to claim 1, wherein the contact surface (20) is arranged on a flexible and/or deformable portion (21) of the tool (18), so that the contact surface (20) can adapt to a contour of the container (12) and/or packaging material by pressing.

11. A system comprising a device (10) according to claim 1, at least one container (12) and/or packaging material and/or one nest (30) for receiving the container (12), wherein the contact surface (20) is configured to be complementary to the container (12) and/or packaging material, so that the contact surface (20) can lie flat against the container (12) and/or packaging material.

12. A clean room having a device (10) according to claim 1.

13. A method for handling containers (12) inside a clean room comprising the steps of:
providing a contact surface (20) for contacting a container (12) and/or packaging material, wherein an adhesive-structured polymer film (22) is arranged at least partially on the contact surface (20), or the contact surface (20) has an adhesive-structured polymer surface, wherein the polymer film (22) or the polymer surface is configured such that the contacted container (12) adheres to the polymer film (22) or to the polymer surface as a result of a van der Waals interaction,
pressing the contact surface (20) with the polymer film (22) or the polymer coating (24) onto the container and/or packaging material (12), wherein the pressing is carried out with a predetermined pressure and for a predetermined time period,
handling the container (12) and/or packaging material adhering to the polymer film (22) or the polymer surface as a result of van der Waals forces, wherein the polymer film (22) or the polymer surface is configured to be H2O2-resistant and/or autoclavable.

14. The method according to claim 13, wherein the method further comprises the step of:
positioning the container (12) and/or packaging material in a nest (30) and/or removing the container (12) from a nest (30).

15. The method according to claim 13, wherein a device (10) according to claim 1 is used to carry out the method.

16. The device (10) according to claim 1, wherein the adhesive-structured polymer surface is a polymer coating (24).

17. The device (10) according to claim 2, wherein the polymer surface is a polymer coating (24).

18. The method according to claim 13, wherein the adhesive-structured polymer surface is a polymer coating (24).

19. The device (10) according to claim 5, wherein the at least one resilient element (26) is a spring (28).

20. The device (10) according to claim 7, wherein the contact surface (20) is circular.

21. The device (10) according to claim 8, wherein the contact surface (20) is semi-circular cylindrical.
